(19) United States
(12) Patent Application Publication
(10) Pub. No.: US 2008/0279611 A1
(43) Pub. Date: Nov. 13, 2008

(54) SPRAY BOTTLE WITH EXTRA REFILL OPENING AND BRUSH

(76) Inventor: Jonas Graphenius, Bromma (SE)

Correspondence Address: FASTH LAW OFFICES (ROLF FASTH), 26 PINECREST PLAZA, SUITE 2, SOUTHERN PINES, NC, 28387-4301, US

(21) Appl. No.: 12/116,282

(22) Filed: May 7, 2008

Related U.S. Application Data
(60) Provisional application No. 60/916,508, filed on May 7, 2007.

(51) Int. Cl. B43K 25/00

(52) U.S. Cl. 401/52; 222/192

(57) ABSTRACT

The method is for spraying a liquid with a spray bottle. A container is provided that has a spray unit in operative engagement with a suction tube inside the container in fluid communication with a liquid disposed inside the container. The container has a protrusion with an opening defined therein. The protrusion has a brush attached thereto. The suction tube has a diversion tube extending to the opening. A handle on the spray unit may be used to pump the liquid up through the suction tube. The liquid is diverted from the suction tube to the diversion tube to moisturize the brush.

### PRIOR APPLICATION

This is a US utility patent application that claims priority from U.S. provisional patent application No. 60/916,508, filed 7 May, 2007.

### TECHNICAL FIELD

The present invention relates to a spray container that has an extra refill opening and brush.

### BACKGROUND OF THE INVENTION

Spray bottles are sometimes difficult to use for spraying in narrow and tight areas. It is often difficult to not only safely put away the spray bottle while working in a tight working space but also there may not be enough room to spray. It is often also difficult to refill the spray bottle while being in a narrow or tight space since the spray mechanism must be removed and the suction tube withdrawn from the spray bottle to enable the user to refill the bottle through the opening at the top. There is a need for a spray bottle design that solves the above-mentioned problems.

### SUMMARY OF THE INVENTION

The method of the present invention provides a solution to the above-mentioned problem. More particularly, the method is for spraying a liquid with a spray bottle that has a unique design. A container is provided that has a spray unit in operative engagement with a suction tube inside the container in fluid communication with a liquid disposed inside the container. The container has a protrusion at the lower end of the container with an opening defined therein. The protrusion may have a brush attached thereto. The suction tube has a diversion tube in operative engagement with the suction tube and extends to the opening. A handle on the spray unit may be used to pump the liquid up through the suction tube and the diversion tube. The liquid may be diverted from the suction tube to the diversion tube to moisturize the brush.

### BRIEF DESCRIPTION OF THE DRAWINGS

FIG. 1 is a perspective view of the spray container of the present invention; and

FIG. 2 is a perspective view of a bottom portion of the spray container of the present invention.

### DETAILED DESCRIPTION

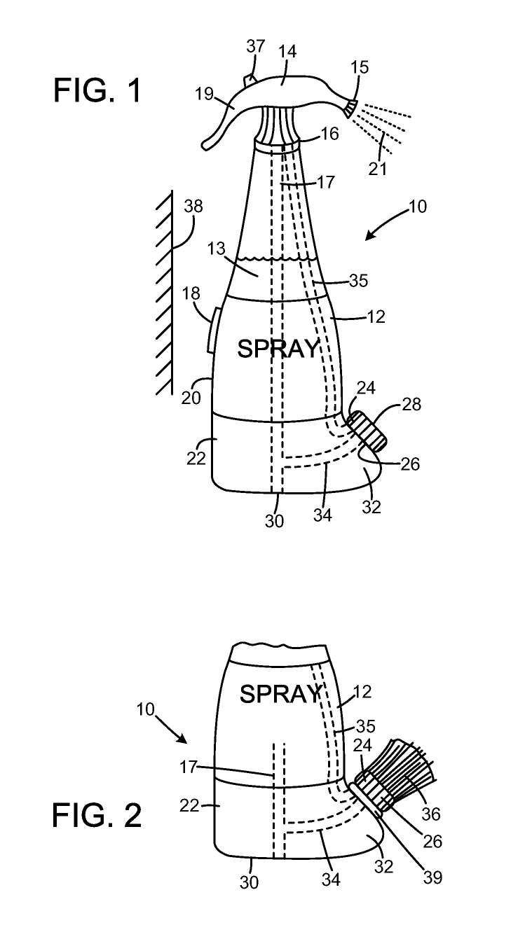

With reference to FIGS. 1-2, the spray bottle 10 of the present invention has a container 12 that contains a liquid 13 such as a cleaning liquid or any other suitable liquid. A spray unit 14 is attached to the container 12 such as by screwing it onto a threaded opening 16 at a top of the container 12. The spray unit 14 has a nozzle 15 and a pumping handle 19. The spray unit 14 is in operative engagement and attached to a suction tube 17 so that the liquid 13 may be pumped up by pumping the handle 19 to withdraw the liquid up through the suction tube 17 and be dispensed as spray 21 through the nozzle 15.

A magnet 18 may be attached to an outside wall 20 of the container 12. The bottle 10 may be attached to metal surface 38 with the magnet 18 so that user can safely put away or hang the bottle in places where it cannot stand or when there is a need to hang the bottle 10 in a high place away from children and others that should be prevented from gaining access to the potentially dangerous liquid 13 in the bottle. The magnet 18 is useful when, for example, working on a car engine since it is often difficult to find a suitable place for the bottle to stand. Preferably, the magnet 18 is attached to the bottle in a place above the middle of the bottle 10 so that the bottle can hang by the magnet in a balanced way to evenly distribute the weight of the bottle 10 when it hangs by the magnet. Of course, the magnet 18 may be attached to the bottle 10 in any suitable place.

A bottom portion 22 of the container 12 has a protrusion 24 that has an opening 26 defined therein. An important feature of the opening 26 is that the container 12 may be refilled without having to remove the spray unit 14 and withdraw the suction tube 17 from the container so that liquid may be poured into the container through the top opening 16. A lid 28 may be screwed onto the protrusion 24 to prevent the liquid 13 from leaking out through the opening 26 when the container 12 is standing on a bottom surface 30. The lid 28 may be tamper proof so that children cannot remove the lid 28.

The bottom portion 22 has an expanded portion 32 that extends forwardly in the same forward direction as the nozzle 15 so that the protrusion 24 protrudes outwardly and slightly upwardly.

The suction tube 17 is in operative engagement and in fluid communication with a diversion tube 34 that extends from a bottom of the suction tube 17 to the opening 26. A communication tube 35 extends from the spray unit 14 to the opening 26 in the protrusion 24 so that by pumping the handle 19, suction is created in the diversion tube 34 also even when the suction tube 17 is not operating. The communication tube 35 is in fluid communication and operative engagement with the diversion tube 34.

The lid 28 may be removed and replaced by a brush 36, sponge or any other cleaning device that is attached to or screwed onto the protrusion 24 so that the brush 36 is in fluid communication with the diversion tube 34 and the communication tube 35. A filter 39 may be disposed in the protrusion to prevent dirt from getting into the tube sections 17, 34 and 35. The spray unit 14 may have a switch 37 so that the user can switch between spraying through the nozzle 15 and/or through the brush 36. Preferably, the brush 36 is directed in an outwardly and slightly upward direction away from the bottom surface 30. By pumping the handle 19, liquid is pumped up through the suction tube 17 and also through the diversion tube 34 to flow out through the opening 26 and into the brush 36 to moisturize the brush 36 with the liquid 13. It may be possible to close the diversion tube 34 so that no liquid is diverted through the opening 26 while pumping liquid through the nozzle 15. It may also be possible to keep the diversion tube 34 open and close the opening 26 by the lid 28 when it is not desirable to divert liquid through the diversion tube 34. Similarly, it may be possible to close the nozzle 15 when it is desirable to only pump the liquid 13 through the diversion tube 34 and into the brush 36 but not through the nozzle 15.

It may also be possible to provide the device with an adjustment mechanism so that the user may close the flow through the opening 26 by for example, turning or twisting the brush or lid so that it is not necessary to manipulate the mechanism 37. The brush 36 may also be adjustable so that it may be moved to point upwardly or downwardly as desired.

While the present invention has been described in accordance with preferred compositions and embodiments, it is to be understood that certain substitutions and alterations may be made thereto without departing from the spirit and scope of the following claims.

1. A method for spraying a liquid with a spray bottle, comprising:
providing a container having a spray unit in fluid communication with a suction tube inside the container in fluid communication with a liquid disposed inside the container, the container having a protrusion with an opening defined therein, the protrusion having a brush attached thereto, the suction tube having a diversion tube extending to the opening;
pumping a handle on the spray unit to pump the liquid up through the suction tube; and
diverting the liquid from the suction tube to the diversion tube to moisturize the brush.

2. The method according to claim 1 wherein the method further comprises attaching a magnet to the container and attaching the magnet to a surface to hang the container by the magnet.

3. The method according to claim 1 wherein the method further comprises closing a nozzle on the spray unit so that the liquid is only pumped to the brush but not through the nozzle.

4. The method according to claim 1 wherein the method further comprises replacing the brush with a lid so that the liquid is only pumped up through the suction tube and out via a nozzle of the spray unit.

5. The method according to claim 4 wherein the method further comprises removing the lid and refilling the container with the liquid through the opening.

6. The method according to claim 1 wherein the method further comprises spraying the liquid through a nozzle while moisturizing the brush by pumping a handle on the spray unit.

7. The method according to claim 1 wherein the method further comprises refilling the container through the opening without removing the spray unit.
